(19) United States
(12) Patent Application Publication
(10) Pub. No.: US 2017/0261723 A1
(43) Pub. Date: Sep. 14, 2017

(54) PERISCOPIC 12X ZOOM CELL PHONE CAMERA LENS WITH EIGHT MILLION PIXELS

(71) Applicant: NATIONAL CENTRAL UNIVERSITY, Taoyuan City 320 (TW)

(72) Inventors: WEN-HSIN SUN, TAOYUAN CITY 320 (TW); YU-HAO CHAO, KEELUNG CITY 204 (TW)

(21) Appl. No.: 15/065,221

(22) Filed: Mar. 9, 2016

(51) Int. Cl. G02B 13/00; G02B 15/22; G02B 15/177

(52) U.S. Cl. CPC G02B 13/009; G02B 13/0065; G02B 15/177; G02B 15/22

(57) ABSTRACT

A periscopic 12× zoom cell phone camera lens with eight million pixels comprises a first lens set arranged between an object side and an imaging surface, a second lens set arranged between the first lens set and the imaging surface, a third lens set arranged between the second lens set and the imaging surface, and an image sensor fixed at the imaging surface. The first lens set includes a prism, a first lens, and a second lens. The second lens set includes a third lens and a fourth lens. The third lens set includes a fifth lens. The light path is turned 90° due to the prism so that the length of the prism is equal to a thickness of the cell phone camera lens and the 60 mm length of the cell phone camera lens may be assembled in the cell phone to achieve 12× zoom.

### BACKGROUND OF THE INVENTION

1. Field of the Invention

The present invention relates to a cell phone camera lens, and especially relates to a periscopic 12× zoom cell phone camera lens with eight million pixels.

2. Description of Related Art

Now, most of the cell phone camera lens are prime lens due to the advantages of simple manufacture and small size. Although the cell phone has the function of digital zoom, the digital zoom ratio is finite and parts of quality may be expended compared to optical zoom. The digital zoom needs to move lens set to change focal length so that the space is too large to reduce the volume.

In 2007, Matsusaka et al. had designed a 2.76× zoom cell phone camera lens with three million pixels which comprises five aspherical lens. The aperture value (F#) is ranged from 3.3 to 3.9. The length of the camera lens is 20 mm. C. C. Liao had designed a 2.83× zoom camera lens comprised four six-lens sets which are include seven aspherical surfaces and the length thereof is 20.5 mm. C. W. Chang et al. had designed a 2.44× zoom cell phone camera lens with three million pixels which comprises five aspherical lens. The length of the camera lens is 16.5 mm. In 2012, H. C. Tang et al. had designed a 1.37× zoom camera lens comprised three five-lens sets which includes four aspherical surfaces and one spherical surface. The length thereof is 29.327 mm and the maximum diameter is 9 mm.

The telescopic design may turn the light path with a right-angle prism so that the moving pat of the lens may be moved in opposite direction to improve the drawback which is that the thickness of the camera lens is too thick due to the length thereof. It is gradually applied to the cell phone. The zoom camera lens may be hidden in the cell phone to overcome the drawback of large volume. In 2009, J. H. Chung et al. had designed a telescopic 3× zoom camera lens with three lens sets which has five million pixels. The focal length is ranged from 4.75 mm to 14.25 mm. The aperture value (F#) is ranged from 3.5 to 6.8. The viewing angle is ranged from 61.7° to 23.7°. The length of the camera lens is 28 mm. The thickness of the camera lens is 9 mm. The relative brightness is ranged from 50% to 85%. The optical aberration is arranged from −4.5% to 1.0%.

In 2008, S. C. Park et al. had designed a telescopic 2.9× zoom camera lens having four lens sets without using the right-angle prism. The thickness thereof is 7 mm. The length thereof is 37.56 mm. In 2009, S. C. Park et al. had designed a telescopic 5× zoom camera lens having five lens sets. The thickness thereof is 8 mm. The length thereof is 40 mm.

In 2012, S. C. Chia had designed a telescopic 2.55× zoom camera lens having three lens sets which comprises a right-angle prism and six lenses. The thickness thereof is 8.23 mm. The length thereof is 35.83 mm. However, there is a light collecting lens arranged in front of the right-angle prism so as to increase the thickness.

In 2013, S. C. Park et al. had designed a telescopic 9.5× zoom camera lens having four lens sets which comprise one right-angle prism and ten lenses. A first lens set is fixed. The focal length of the camera lens is ranged from 4.2 mm to 39.9 mm. The aperture value (F#) of the camera lens is ranged from 3.5 to 4.5. The side length of the right-angle prism is 12 mm which is also the thickness of the camera lens. And the length of the camera lens is 53 mm.

In conclusion, there are many drawbacks for conventional cell phone camera lens described as follows.

Firstly, the recent cell phone camera lens is limited to the installation space. The structure of the zoom camera lens may be not reduces to assembled or installed in the cell phone to achieve the effect of 12× zoom.

Secondly, since the optical zoom is needed to move the lens sets to change the focal length, it needs more space. It is hard to reduce the volume of the 12× zoom cell phone camera lens and expend the image quality.

In view of the foregoing circumstances, the inventor has invested a lot of time to study the relevant knowledge, compare the pros and cons, research and develop related products. After quite many experiments and tests, the “periscopic 12× zoom cell phone camera lens with eight million pixels” of this invention is eventually launched to improve the foregoing shortcomings, to meet the public use.

### SUMMARY OF THE INVENTION

A main object of this invention is providing a periscopic 12× zoom cell phone camera lens with eight million pixels. The light path is turned 90° due to the right-angle prism with 7 mm length which is arranged in front of the cell phone camera lens so that the length of the prism is equal to a thickness of the cell phone camera lens. With the different concave-convex arrangements and curvature radii of above mentioned three lenses, the arrangements of the three lenses may be changed in the 60 mm length of the cell phone camera lens to achieve 12× optical zoom. The length and thickness of the cell phone camera lens are effectively controlled to be capable for assembling in the cell phone. The cell phone camera lens is optimized so as to make the imaging quality reach certain criteria. The operation of 12× zoom may be without expense of quality to reach a batter imaging quality.

In order to achieve above mentioned object, a periscopic 12× zoom cell phone camera lens with eight million pixels is used for imaging an image of a view arranged in an object side to an imaging surface of an imaging side opposite to the object side and comprises a first lens set, arranged between the object side and the imaging surface and including a prism, a first lens, and s second lens, the prism is arranged between the object side and the imaging surface, the first lens is a concave lens and arranged between the prism and the imaging surface, and the second lens is a convex lens and arranged between the first lens and the imaging surface; a second lens set, arranged between the first lens set and the imaging surface and including a third lens, a fourth lens, and a first driving member, the third lens is a convex lens and arranged between the first lens set and the imaging surface, the fourth lens is a concave lens and arranged between the third lens and the imaging surface, and the first driving member is driven the second lens set to move relative to the first lens set; a third lens set, arranged between the second lens set and the imaging surface and including a fifth lens and a second driving member, the fifth lens is a convex lens, and the second driving member is driven the fifth lens to move relative to the first lens set; and an image sensor, fixed at the imaging surface; wherein the second lens set and the third lens set are moved relative to the first lens set to perform zooming, the second lens set is moved close to the first lens set and the fifth lens of the third lens set is moved close to the imaging surface so as to form a telescopic focal-length mode, the second lens set is moved far away from the first lens set and the fifth lens is moved close to the third lens set so as to form a wide-angle focal-length mode, and a focal length of the telescopic focal-length mode is twelve times a focal length of the wide-angle focal-length mode.

In some embodiments, a minimum of the focal length of the wide-angle focal-length mode is 4 mm, and a maximum of the telescopic focal-length mode is 48 mm.

In some embodiments, a length of the prism is 7 mm, diameters of the first lens, the second lens, the third length, the fourth lens, and the fifth lens are smaller than 7 mm, and a distance between the prism and the imaging surface is 60 mm.

In some embodiments, the first lens is a biconcave lens and a curvature radius thereof is (7.5804, −2.6258), and the second lens is a biconvex lens and a curvature radius thereof is (−6.8431, 24.1316).

In some embodiments, the first driving member of the second lens set is a step motor, the third lens is a biconvex lens and a curvature radius thereof is (−2.8586, 2.0899), and the fourth lens is a biconcave lens and a curvature radius thereof is (1.7089, −15.7804).

In some embodiments, the second driving member of the third lens set is a step motor, and the fifth lens is a biconvex lens and a curvature radius thereof is (−7.6779, 7.0312).

In some embodiments, a resolution of the image sensor is eight million pixels and further combined with a protective glass, and the protective glass is arranged at one side of the image sensor corresponding to the third lens set.

In some embodiments, the image sensor is further combined with an infrared filtered lens which is arranged between the protective glass and the third lens set.

The various objects and advantages of the present invention will be more readily understood from the following detailed description when read in conjunction with the appended drawing.

### BRIEF DESCRIPTION OF THE DRAWINGS

FIG. 1 is a plan view of a periscopic 12× zoom cell phone camera lens with eight million pixels of the present invention while being at a position of a wide-angle focal-length mode;

FIG. 2 is a plan view of the periscopic 12× zoom cell phone camera lens with eight million pixels of the present invention while is being at a position of a middle focal length;

FIG. 3 is a plan view of the periscopic 12× zoom cell phone camera lens with eight million pixels of the present invention while being at a position of a telescopic focal-length mode;

FIG. 4 is an image quality evaluation curve diagram of the periscopic 12× zoom cell phone camera lens with eight million pixels of the present invention while being imaged at 30° of the wide-angle focal-length mode;

FIG. 5 is an image quality evaluation curve diagram of the periscopic 12× zoom cell phone camera lens with eight million pixels of the present invention while being imaged at 15° of the middle focal length;

FIG. 6 is an image quality evaluation curve diagram of the periscopic 12× zoom cell phone camera lens with eight million pixels of the present invention while being imaged at 10° of the telescopic focal-length mode; and

FIG. 7 is a curve diagram of the periscopic 12× zoom cell phone camera lens with eight million pixels of the present invention which shows the telescopic focal length, the middle focal length, and the wide-angle focal length versus various viewing angles.

### DETAILED DESCRIPTION OF THE INVENTION

To describe clearly that the present invention achieves the foregoing object and function, the technical features and desired function are described with reference to a preferred embodiment and accompanying drawings.

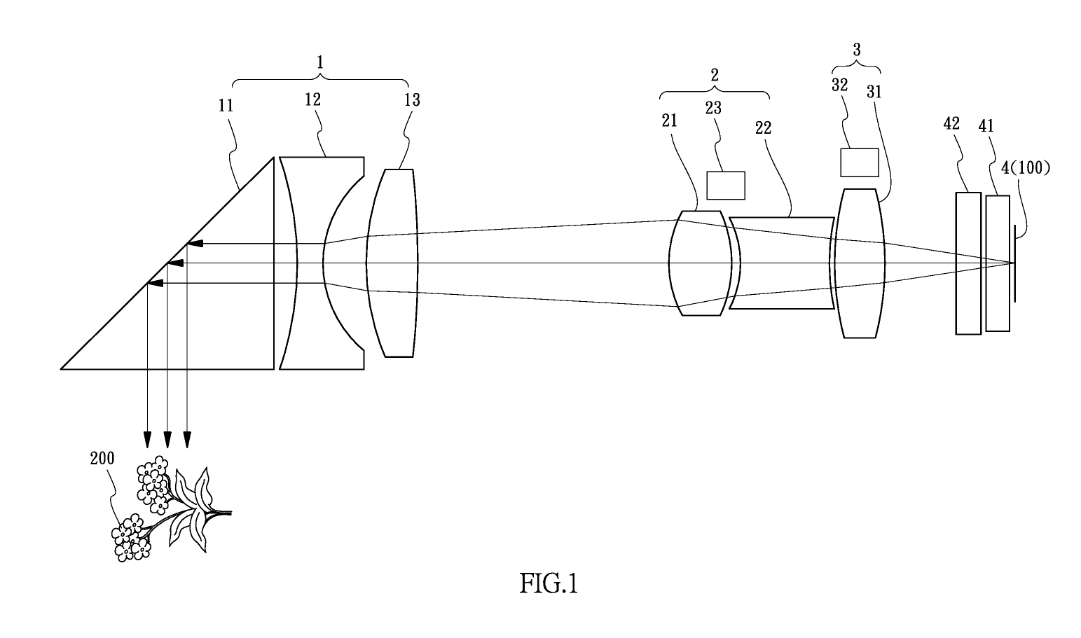

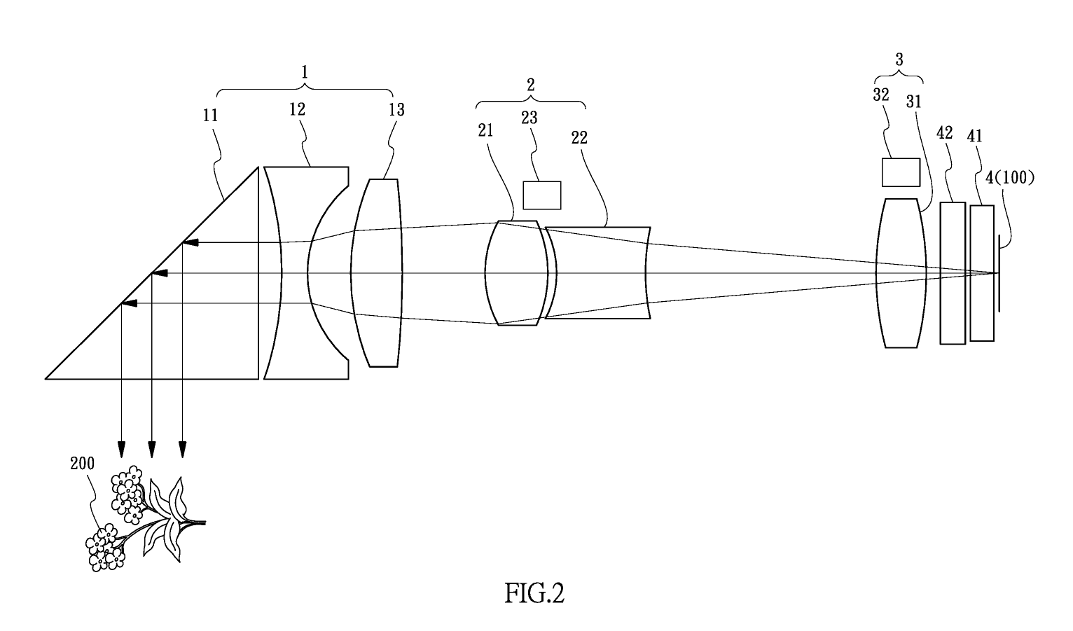

Please reference to FIGS. 1 to 3, a periscopic 12× zoom cell phone camera lens with eight million pixels of the present invention may be used for imaging an image of a view 200 arranged in an object side to an imaging surface 100 of an imaging side opposite to the object side. The cell phone camera lens may comprise a first lens set 1, a second lens set 2, a third lens set 3, and an image sensor 4.

The first lens set 1 is arranged between the object side and the imaging surface 200 and includes a prism 11, a first lens 12, and s second lens 13. The prism 11 is arranged between the object side and the imaging surface 100. The first lens 12 is a concave lens and arranged between the prism 11 and the imaging surface 100. The second lens 13 is a convex lens and arranged between the first lens 12 and the imaging surface 100.

The second lens set 2 is arranged between the first lens set 1 and the imaging surface 100 and includes a third lens 21, a fourth lens 22, and a first driving member 23. The third lens 21 is a convex lens and arranged between the first lens set 1 and the imaging surface 100. The fourth lens 22 is a concave lens and arranged between the third lens 21 and the imaging surface 100. The first driving member 23 is driven the second lens set 2 to move relative to the first lens set 1.

The third lens set 3 is arranged between the second lens set 2 and the imaging surface 100 and includes a fifth lens 31 and a second driving member 32. The fifth lens 31 is a convex lens and the second driving member 32 is driven the fifth lens 31 to move relative to the first lens set 1. The image sensor 4 is fixed at the imaging surface.

The second lens set 2 and the third lens set 3 are moved relative to the first lens set 1 to perform zooming. The second lens set 2 adjacent to the first lens set 1 and the fifth lens 15 of the third lens set 3 adjacent to the imaging surface 100 are formed a telescopic focal-length mode. The second lens set 2 distant from the first lens set 1 and the fifth lens 15 adjacent to the third lens set 3 are formed a wide-angle focal-length mode. A focal length of the telescopic focal-length mode is twelve times a focal length of the wide-angle focal-length mode.

The above mentioned embodiment is the main skill feature of this invention and corresponds to the claim 1 of this invention to understand the object and embodiments of this invention in detail. And the skill features of the depending claims are for describing the claim 1 in detail or adding more skill features, but not limited thereto. It should be known that the claim 1 is not necessary to include the skill features of the depending claims.

In FIGS. 1 to 3, a minimum of the focal length of the wide-angle focal-length mode is 4 mm and a maximum of the telescopic focal-length mode is 48 mm. Furthermore, a length of the prism 11 is 7 mm. The diameters of the first lens 12, the second lens 13, the third length 21, the fourth lens 22, and the fifth lens 31 are smaller than 7 mm. A distance between the prism 11 and the imaging surface 100 (a length of the cell phone camera lens) is 60 mm. The first lens 12 is a biconcave lens and a curvature radius thereof is (7.5804, −2.6258). The second lens is a biconvex lens and a curvature radius thereof is (−6.8431, 24.1316). The first driving member 23 of the second lens set 2 is a step motor. The third lens 21 is a biconvex lens and a curvature radius thereof is (−2.8586, 2.0899). The fourth lens 22 is a biconcave lens and a curvature radius thereof is (1.7089, −15.7804). The second driving member 32 of the third lens set 3 is a step motor. The fifth lens 15 is a biconvex lens and a curvature radius thereof is (−7.6779, 7.0312). In addition, a resolution of the image sensor 4 is eight million pixels and further combined with a protective glass 41. The protective glass 41 is arranged at one side of the image sensor 4 corresponding to the third lens set 3. Finally, the image sensor 4 is further combined with an infrared filtered lens 42 which is arranged between the protective glass 41 and the third lens set 3.

In FIG. 1, with the different concave-convex arrangements and curvature radii of above mentioned three lenses, the first lens set 1 is fixed. The second lens set 2 and the third lens set 3 may be driven by the first driving member 23 and the second driving member 32 (which may be step motors) respectively which may be digitally set (that is, the digital focal setting built-in the cell phone) so that the second lens set 2 and the third lens set 3 may be moved relative to the first lens set 1 to perform the operation of zoom. When the second lens set 2 is moved far away from the first lens set 1 and close to the fifth lens 15 of the third lens set 2, it may formed a wide-angle focal-length mode. The minimum of the focal length in the wide-angle focal-length mode is 4 mm.

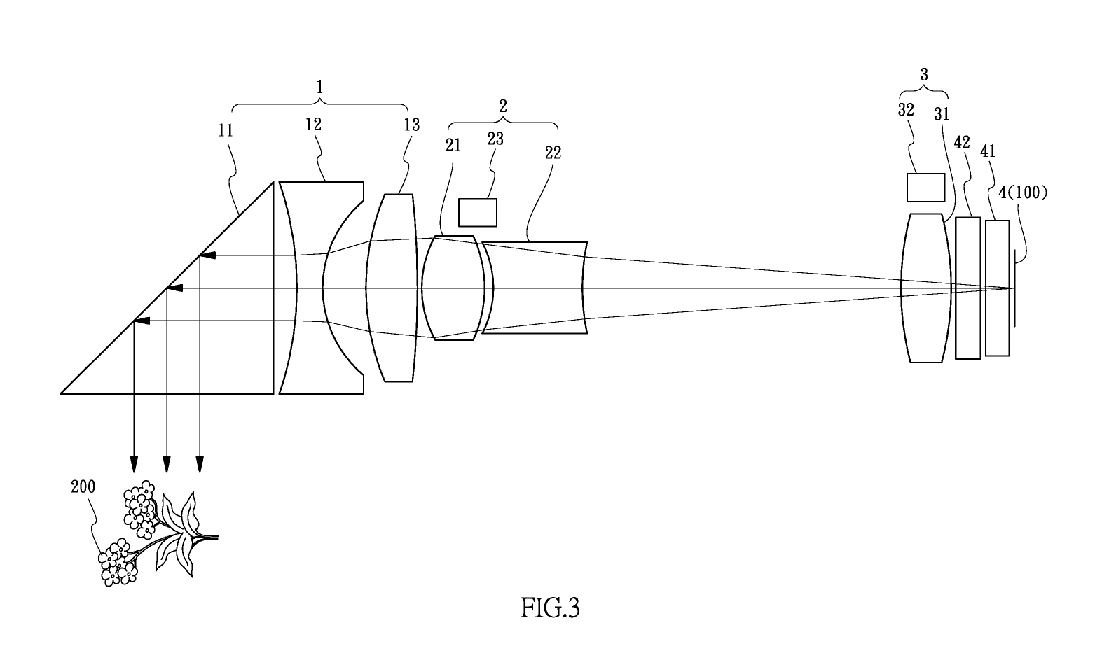

In FIG. 3, with different concave-convex arrangements and curvature radii of above mentioned three lenses, the second lens set 2 and the third lens set 3 may be driven by the first driving member 23 and the second driving member 32 (which may be step motors) respectively which may be digitally set (that is, the digital focal setting built-in the cell phone) so that the second lens set 2 and the third lens set 3 may be moved relative to the first lens set 1 to perform the operation of zoom. When the second lens set 2 is moved close to the first lens set 1 and the fifth lens 15 of the third lens set 2 is moved close to the imaging surface 100, it may formed a telescopic focal-length mode. The maximum of the focal length in the telescopic focal-length mode is 48 mm (it is twelve times the minimum of the focal length in the wide-angle focal-length mode 4 mm).

As above mentioned, the light path is turned 90° due to the right-angle prism with 7 mm length so that the length of the prism 11 is equal to a thickness of the cell phone camera lens. With the different concave-convex arrangements and curvature radii of above mentioned three lenses, the arrangements of the three lenses may be changed in the 60 mm length of the cell phone camera lens to achieve 12× optical zoom so that the cell phone camera lens with the thickness and the length may be assembled in the cell phone.

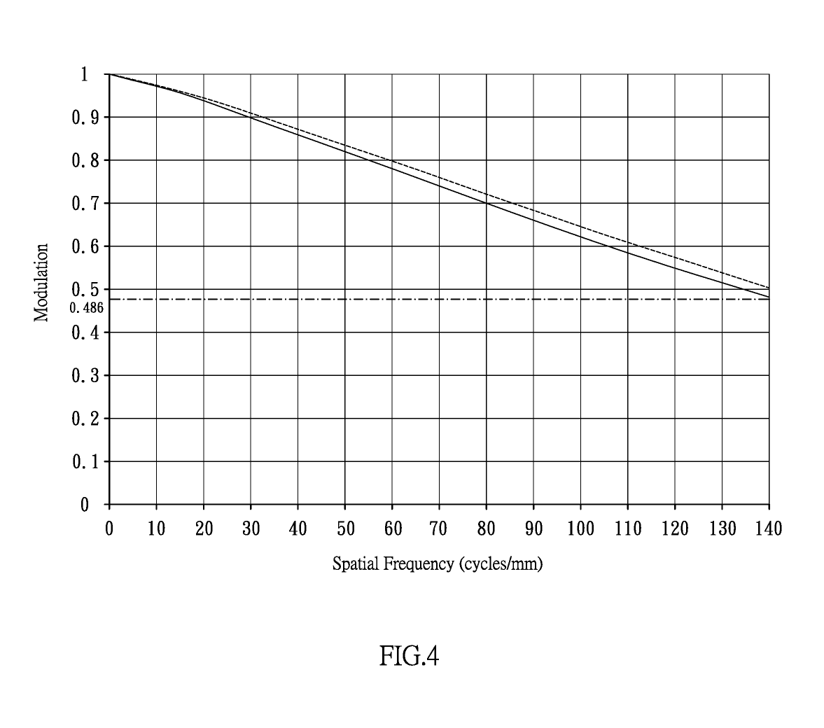

FIG. 4 is an image quality evaluation curve diagram of the periscopic 12× zoom cell phone camera lens with eight million pixels of the present invention while being imaged at 30° of the wide-angle focal-length mode. In FIG. 4, the abscissa is referred to Spatial Frequency and the ordinate is referred to Modulation of imaging quality. The solid line is referred to a tangential direction (X) and the broken line is referred to a radial direction (Y). According to the horizontal broken line corresponding to the abscissa, it is known that a minimum of the simulating imaging quality evaluation is 0.486.

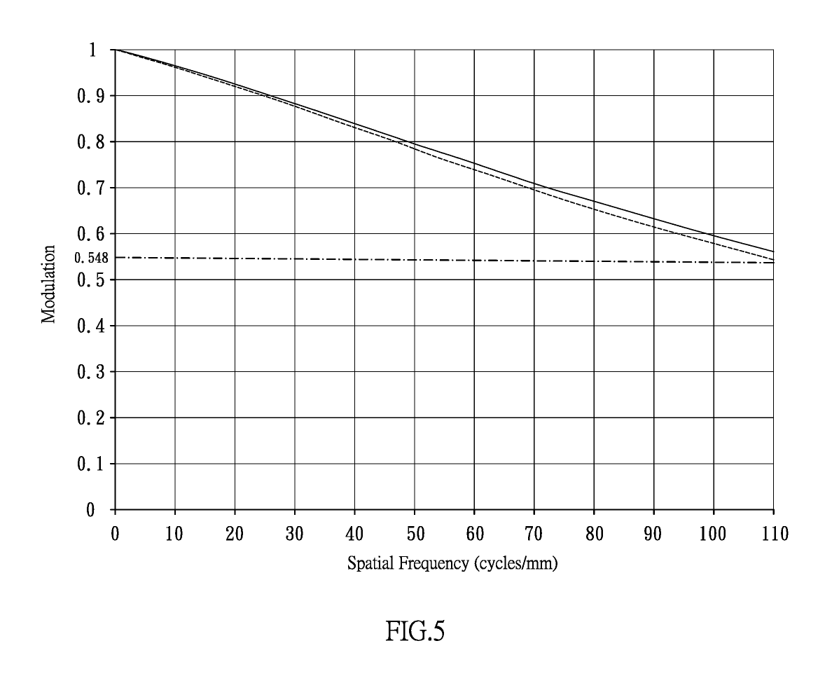

FIG. 5 is an image quality evaluation curve diagram of the periscopic 12× zoom cell phone camera lens with eight million pixels of the present invention while being imaged at 15° of the middle focal length. In FIG. 5, according to the horizontal broken line corresponding to the abscissa, it is known that a minimum of the simulating imaging quality evaluation is 0.548.

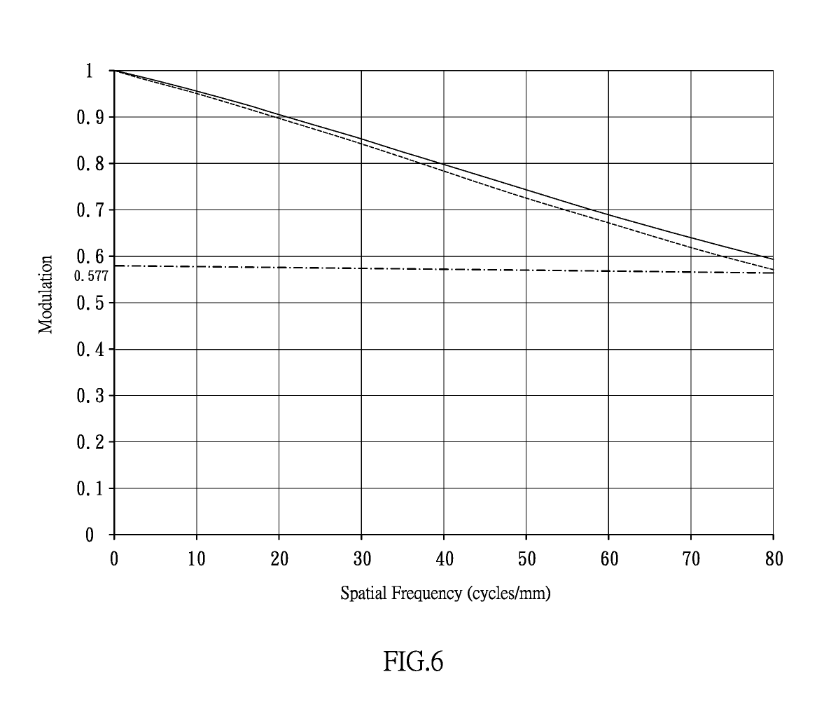

FIG. 6 is an image quality evaluation curve diagram of the periscopic 12× zoom cell phone camera lens with eight million pixels of the present invention while being imaged at 10° of the telescopic focal-length mode. In FIG. 6, according to the horizontal broken line corresponding to the abscissa, it is known that a minimum of the simulating imaging quality evaluation is 0.577.

In summary of the above mentioned simulating imaging quality evaluation in FIGS. 4 to 6, it is known that a minimum of the simulating imaging quality evaluation of the present invention is 0.486.

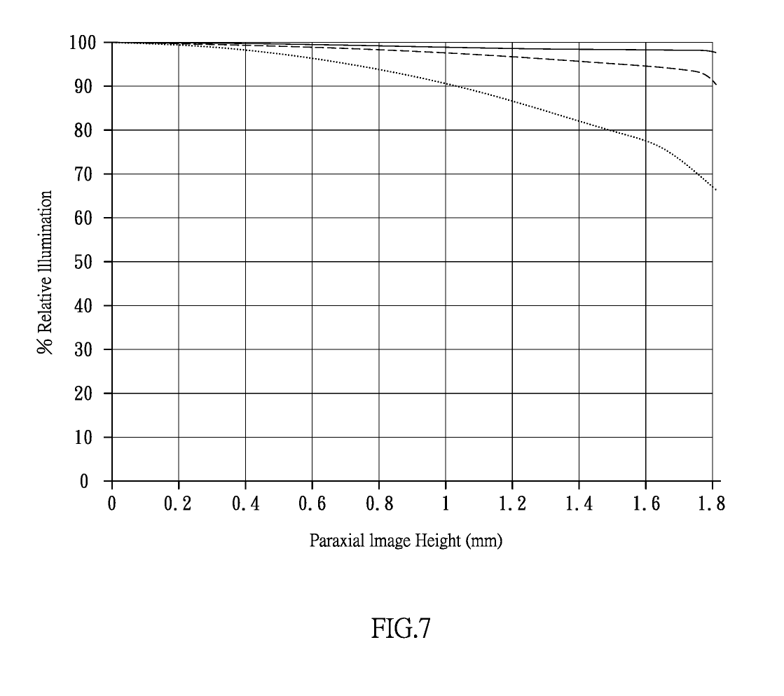

FIG. 7 is a curve diagram of the periscopic 12× zoom cell phone camera lens with eight million pixels of the present invention which shows the telescopic focal length, the middle focal length, and the wide-angle focal length versus various viewing angles. In FIG. 7, the abscissa is referred to Paraxial Image Height and the ordinate is referred to Relative illumination. The solid line is referred to the telescopic focal length, the broken line is referred to the middle focal length, and the dot line is referred to the wide-angle focal length. The trough of the dot line is 6.5965. It is known that a minimum of the relative illumination of the present invention is 67.5965%.

It is known from FIGS. 4 to 7 that the periscopic 12× zoom cell phone camera lens with eight million pixels of the present invention is optimized to reach certain criteria in the imaging quality and the relative illumination (the performance of the imaging quality is larger than 0.486% and the performance of the relative illumination is larger than 67.5965%). Without the expense of image quality, the optical zoom is transcended the current technical threshold so as to achieved 12× zoom.

In conclusion, the cell phone camera lens of the present invention may improve the drawbacks and overcome difficulties to achieve following advantages.

Firstly, the light path is turned 90° due to the right-angle prism with 7 mm length which is arranged in front of the cell phone camera lens so that the length of the prism 11 is equal to a thickness of the cell phone camera lens. With the different concave-convex arrangements and curvature radii of above mentioned three lenses, the arrangements of the three lenses may be changed in the 60 mm length of the cell phone camera lens to achieve 12× optical zoom.

Secondly, the length and thickness of the cell phone camera lens are effectively controlled to be capable for assembling in the cell phone. The cell phone camera lens is optimized so as to make the imaging quality reach certain criteria. The operation of 12× zoom may be without expense of quality to reach a batter imaging quality.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A periscopic 12× zoom cell phone camera lens with eight million pixels, used for imaging an image of a view arranged in an object side to an imaging surface of an imaging side opposite to the object side, the lens comprising:
a first lens set, arranged between the object side and the imaging surface and including a prism, a first lens, and s second lens, the prism is arranged between the object side and the imaging surface, the first lens is a concave lens and arranged between the prism and the imaging surface, and the second lens is a convex lens and arranged between the first lens and the imaging surface;
a second lens set, arranged between the first lens set and the imaging surface and including a third lens, a fourth lens, and a first driving member, the third lens is a convex lens and arranged between the first lens set and the imaging surface, the fourth lens is a concave lens and arranged between the third lens and the imaging surface, and the first driving member is driven the second lens set to move relative to the first lens set;
a third lens set, arranged between the second lens set and the imaging surface and including a fifth lens and a second driving member, the fifth lens is a convex lens, and the second driving member is driven the fifth lens to move relative to the first lens set; and
an image sensor, fixed at the imaging surface;
wherein the second lens set and the third lens set are moved relative to the first lens set to perform zooming, the second lens set is moved close to the first lens set and the fifth lens of the third lens set is moved close to the imaging surface so as to form a telescopic focal-length mode, the second lens set is moved far away from the first lens set and the fifth lens is moved close to the third lens set so as to form a wide-angle focal-length mode, and a focal length of the telescopic focal-length mode is twelve times a focal length of the wide-angle focal-length mode.

2. The cell phone camera lens as claimed in claim 1, wherein a minimum of the focal length of the wide-angle focal-length mode is 4 mm, and a maximum of the telescopic focal-length mode is 48 mm.

3. The cell phone camera lens as claimed in claim 1, wherein a length of the prism is 7 mm, diameters of the first lens, the second lens, the third length, the fourth lens, and the fifth lens are smaller than 7 mm, and a distance between the prism and the imaging surface is 60 mm.

4. The cell phone camera lens as claimed in claim 1, wherein the first lens is a biconcave lens and a curvature radius thereof is (7.5804, −2.6258), and the second lens is a biconvex lens and a curvature radius thereof is (−6.8431, 24.1316).

5. The cell phone camera lens as claimed in claim 1, wherein the first driving member of the second lens set is a step motor, the third lens is a biconvex lens and a curvature radius thereof is (−2.8586, 2.0899), and the fourth lens is a biconcave lens and a curvature radius thereof is (1.7089, −15.7804).

6. The cell phone camera lens as claimed in claim 1, wherein the second driving member of the third lens set is a step motor, and the fifth lens is a biconvex lens and a curvature radius thereof is (−7.6779, 7.0312).

7. The cell phone camera lens as claimed in claim 1, wherein a resolution of the image sensor is eight million pixels and further combined with a protective glass, and the protective glass is arranged at one side of the image sensor corresponding to the third lens set.

8. The cell phone camera lens as claimed in claim 7, wherein the image sensor is further combined with an infrared filtered lens which is arranged between the protective glass and the third lens set.
